(19) United States
(12) Patent Application Publication
(10) Pub. No.: US 2012/0228942 A1
(43) Pub. Date: Sep. 13, 2012

(54) ELECTRIC POWER GENERATION SYSTEM, METHOD OF CONTROLLING A BATTERY, COMPUTER-READABLE RECORDING MEDIUM WHICH RECORDS A CONTROL PROGRAMS AND DEVICE CONTROLLING A BATTERY

(75) Inventors: Takeshi NAKASHIMA, Moriguchi-shi (JP); Chie Sugigaki, Moriguchi-shi (JP)

(73) Assignee: SANYO Electric Co., Ltd., Moriguchi-shi (JP)

(21) Appl. No.: 13/425,175

(22) Filed: Mar. 20, 2012

Related U.S. Application Data
(63) Continuation of application No. PCT/JP2011/058088, filed on Mar. 30, 2011.

(30) Foreign Application Priority Data
Mar. 30, 2010 (JP) 2010-079419

(51) Int. Cl. H02J 7/34; H02J 7/00

(52) U.S. Cl. 307/66; 320/101

(57) ABSTRACT

This electric power generation system comprises a power generator, a battery configured to store electric power generated by the power generator, a detector configured to acquire a first power amount data for every first time interval and a second power amount data for every second time interval which is shorter than the first time interval, a controller configured to compute a target output value for the electric power to be supplied to the electric power transmission system based on the first power amount data, to compute a charge or discharge value that is an amount of electric power for charging or discharging the battery based on the target output value, to correct the charge or discharge value based on the second power amount data, and to charge or discharge the line with electric power corresponding to the charge or discharge value from the battery.

### CROSS-REFERENCE TO RELATED APPLICATIONS

This application is a continuation of International Application No. PCT/JP2011/058088, filed Mar. 30, 2011, which claims priority from Japanese Patent Application No. 2010-079419, filed Mar. 30, 2010, the entire contents of which are incorporated herein by reference.

### FIELD OF INDUSTRIAL USE

The present invention relates to an electric power generation system, a method of controlling a battery, a computer-readable recording medium which records a control programs and a device controlling a battery

### PRIOR ART

In recent years, the number of instances where power generators (such as solar cells and the like) utilizing renewable energy such as wind power or sunlight are connected to consumers (e.g. consumer homes and factories) in receipt of a supply of alternating power from an electricity substation has increased. These types of power generators are connected to the power grid subordinated to a substation, and power generated by the power generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the electric grid is termed “counter-current power”.

In this situation the power suppliers, such as the power companies and the like, have a duty to ensure the stable supply of electric power and need to maintain the stability of the frequency and voltage of the overall power grid, including the counter-current power components. For example, the power companies maintain the stability of the frequency of the overall electric power grid by a plurality of methods in correspondence with the size of the fluctuation period. Specifically, in general, in respect of a load component with a variable period of more than the order of 20 minutes, economic dispatching control (EDC) is performed to enable output sharing of the generated amount in the most economical manner. This EDC is controlled based on the daily load fluctuation expectation, and it is difficult to respond to the increases and decreases in the load fluctuation from minute to minute and second to second (the components of the fluctuation period which are less than the order of 20 minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by means of the endogenous control functions of the power grid itself. Moreover, for the components with a fluctuation period of about 10 seconds to the order of several minutes, they can be dealt with by the governor-free operation of the power generators in each generating station. Furthermore, for the components with a fluctuation period of the order of several minutes to 20 minutes, they can be dealt-with by load frequency control (LFC). In this load frequency control, the frequency control is performed by the adjustment of the generated power output of the generating station for LFC by means of a control signal from the central power supply command station of the power supplier.

However, the output of power generators utilizing renewable energy may vary abruptly in correspondence with the weather and such like. This abrupt fluctuation in the power output of this type of power generator applies a gross adverse impact on the degree of stability of the frequency of the power grid which the power generator is connected to. This adverse impact becomes more pronounced as the number of consumers with power generators using renewable energy increases. As a result, in the event that the number of consumers with power generators utilizing renewable energy increases even further henceforth, there will be a need arising for sustenance of the stability of the power grid by the control of the abrupt variation in the output of the power generators.

In relation to that, there have been proposals, conventionally, to provide power generation systems with batteries to enable the storage of electricity resulting from the power output generated by these types of power generators, in addition to the power generators utilizing renewable energy, in order to control the abrupt fluctuation in the power output of these distributed type power generators. Such a power generation system was disclosed, for example, in Japanese laid-open patent publication No. 2001-5543.

In the Japanese laid-open published patent specification 2001-5543 described above, there is the disclosure of a power system provided with solar cells, and inverters which are connected to both the solar cells and the power grid, and a battery which is connected to a bus which connects the inverter and the solar cells. In this power generation system, by acquiring the generated power data for fixed time intervals (detected power output data), as well as computing a target output value by means of the moving averages method based on past power output data and performing electrical charging and discharging of a battery based on the target output value. The charge and discharge power of the battery becomes the difference between the target output value and the actual generated power output at the time point of computing the target output value. By charging and discharging of the battery in accordance with the fluctuation of the generated power output, the fluctuation in the power output from the inverter can be suppressed. Because this enables the suppression of the fluctuations in the power output to the power grid, the suppression of the adverse effects on the frequency of the power grid is enabled.

However, while not clear from Japanese laid-open published patent specification 2001-5543 described above, but the target output value is not continuously computed all the time, and is computed every time new generated power data is acquired (at the fixed time interval which is acquisition interval of the generated power data), and a determination is reached every time the target power is computed as to whether to charge or discharge the battery. The charge or discharge power of the battery determined at the computation time point of the target output value can be considered a fixed power output until the next new charge or discharge power is determined at a subsequent computation point in time of the next target output value.

### PRIOR ART REFERENCES

Patent Reference #1: Japanese laid-open published patent specification 2001-5543.

### OUTLINE OF THE INVENTION

### Problems to be Solved by the Invention

However, in the situation where a fixed power output is charged or discharged by a battery from when the target output value is determined until the determination point of the next target output value, the following problems arise. In other words, in the event that the time interval from when the target output value is determined until the determination point of the next target output value is long, the actual generated power output fluctuates irrespective of the charge or discharge of the battery being fixed during that interval, and there is the problem that the fluctuations in the power output to the power grid cannot be suppressed sufficiently. Moreover, in the event that the time interval from when the target output value is determined until the determination point of the next target output value is short (The detection time interval for generated power data), because the charge and discharge of the battery is controlled minutely, the suppression of the fluctuations in the power output to the power grid is enabled. On the other hand, in the event that the target output value is computed, for example, using the moving averages method based on the power output data in a specific period, the power output data required for computation is too large, in addition to a control device having a CPU capable of high speed computation being required, leading to the problem that the price of the system grows high.

This invention was conceived of to resolve the type of problems described above, and one object of this invention is the suppression of the need for the introduction of a system which has a large memory capacity and which enables high speed computing, in addition to the provision of a power supply system enabling the suppression of adverse impact on the power grid caused by fluctuations in the generated power output by the power generators, as well as the provision of a power supply method and a control program for the power supply system.

### SUMMARY OF THE INVENTION

In order to achieve the objectives described above, the electric power generation system of the present invention comprises a power generator configured to generate electric power using renewable energy, a battery configured to store electric power generated by the power generator, a detector configured to acquire a first power amount data for every first time interval and a second power amount data for every second time interval which is shorter than the first time interval, the first power amount data and the second power amount data being amounts of electric power flowing on a line connecting the power generator and an electric power transmission system, a controller configured to compute a target output value for the electric power to be supplied to the electric power transmission system based on the first power amount data, to compute a charge or discharge value that is an amount of electric power for charging or discharging the battery based on the target output value, to correct the charge or discharge value based on the second power amount data, and to charge or discharge the line with electric power corresponding to the charge or discharge value from the battery.

The method of controlling a battery storing electric power generated by a power generator generating electric power using renewable energy of the present invention comprises detecting a first power amount data for every first time interval and a second power amount data for every second time interval which is shorter than the first time interval, the first power amount data and the second power amount data being amounts of electric power flowing on a line connecting the power generator and an electric power transmission system, computing a target output value for the electric power to be supplied to the electric power transmission system based on the first power amount data, computing an charge or discharge power amount from battery based on the target output value, correcting the charge or discharge power amount based on the second power amount data, and charging or discharging the line with electric power corresponding to the charge or discharge value from the battery.

The computer-readable recording medium of the present invention which records a control programs for causing one or more computers to perform the steps comprises detecting a first power amount data for every first time interval and a second power amount data for every second time interval which is shorter than the first time interval, the first power amount data and the second power amount data being amounts of electric power flowing on a line connecting the power generator and an electric power transmission system, computing a target output value for the electric power to be supplied to the electric power transmission system based on the first power amount data, computing an charge or discharge power amount from battery based on the target output value, correcting the charge or discharge power amount based on the second power amount data, and charging or discharging the line with electric power corresponding to the charge or discharge value from the battery.

### BENEFITS OF THE PRESENT INVENTION

By means of the present invention, by acquiring a second detected power output data on a second time interval which shorter than a first time interval whereon the first detected power output data was acquired in order to compute the target output value and correcting the charged and discharged power output of the battery based on the second detected power output data, the charged and discharged power output of the battery which was determined based on the target output value can be adjusted in accordance with the actual detected power output (second detected power output). By this means, because the performance of charge and discharge of the battery is enabled so as to suppress (smooth) the fluctuations of the actually detected power output better, the more effective suppression of the fluctuations in the power output to the power grid side is enabled, and as a result, the suppression of the adverse effects on the frequency of the power grid is enabled. Moreover, by computing the target output value based on the first detected power output acquired in a relatively long first time interval and performing the charge and discharge control of the battery, the suppression of the increased required detected power output data for the computation of the target output value when the target output value is computed using the relatively short second power output detection data [time interval] is enabled.

### BRIEF DESCRIPTION OF THE DRAWINGS

FIG. 1 is a block diagram showing the configuration of the power supply system of embodiment 1 of the present invention.

FIG. 2 is a drawing to explain the correction of charged and discharge power output on the occasion of performing charge and discharge control of the power supply system of embodiment 1 of the present invention shown in FIG. 1.

FIG. 3 is a drawing to explain the relationship between the intensity of the load fluctuations and the fluctuation periods in respect of the power grid.

FIG. 4 is a flow chart in order to explain the flow of the control of the before initiation of the charge and discharge control of the power supply system of the first embodiment shown in FIG. 1.

FIG. 5 is a flow chart in order to explain the flow of the control of the after initiation of the charge and discharge control of the power supply system of the first embodiment shown in FIG. 1.

FIG. 6 is a diagram in order to explain the sampling intervals in the charge and discharge control.

FIG. 7 is a drawing to explain the trends in the power output to the power grid of the power supply system of the example 1.

FIG. 8 is a drawing to explain the trends in the power output to the power grid of the power supply system of the example 2.

FIG. 9 is a drawing to explain the trends in the power output to the power grid of the power supply system of the comparative example.

FIG. 10 is a block diagram showing the configuration of the power supply system of embodiment 2 of the present invention.

FIG. 11 is a graph in order to explain the charge and discharge control of the power supply system (example 3) of the second embodiment of the present invention.

FIG. 12 is a graph explaining the charge and discharge control of the power supply system (example 4) of the second embodiment of the present invention.

FIG. 13 is a graph in order to explain the effectiveness of the performance of the charge and discharge control of the power supply system (example 3) by means of the second embodiment of the present invention.

FIG. 14 is a graph in order to explain the effectiveness of the performance of the charge and discharge control of the power supply system (example 4) of the second embodiment of the present invention.

FIG. 15 is a graph explaining the effectiveness of the performance of the charge and discharge control of the power supply system (example 3 and example 4) of the second embodiment of the present invention.

FIG. 16 is a block diagram showing the configuration of the power supply system of embodiment 3 of the present invention.

FIG. 17 is a graph in order to explain the charge and discharge control of the power supply system of the third embodiment of the present invention.

### BEST METHOD OF EMBODYING THE INVENTION

Hereafter the embodiments of the present invention are explained based on the figures.

### Embodiment 1

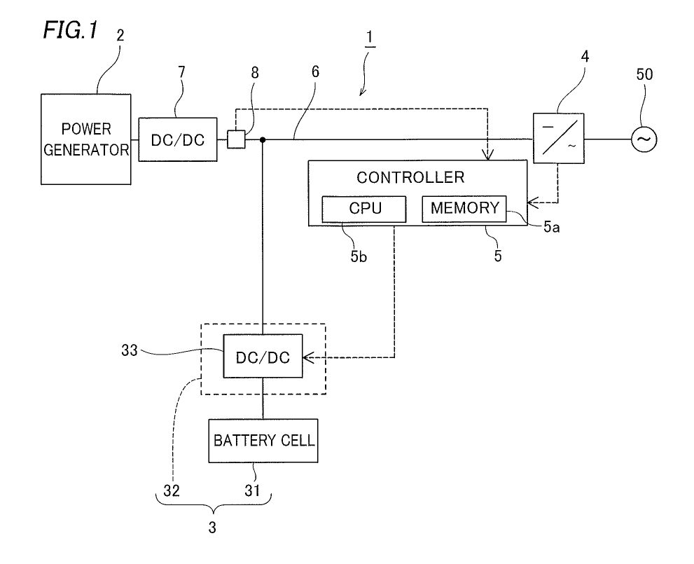

Firstly, the configuration of the power supply system 1 of embodiment 1 of the present invention is explained while referring to FIG. 1˜3.

As shown in FIG. 1, the power generation system 1 is connected to power generator 2 comprised of solar cells and the power grid 50. The power generation system 1 provides the battery 3 which enables the storage of the power generated by the power generator 2, and the power output unit 4 including an inverter outputting power generated by the power generator 2 and the power stored by the battery 3 to the power grid 50 side, and the controller 5 controlling the charge and discharge of the battery 3. Now the power generator 2 may be power generators generating power utilizing renewable energy, and for example may employ wind power generators and the like.

The DC-DC converter 7 is connected in series on the bus 6 connecting the power generator 2 and the power output unit 4. The DC-DC converter 7 converts the direct current voltage of the power generated by the power generator 2 to a fixed direct current voltage (In embodiment 1, approximately 260 V) and outputs to the power output unit 4 side. Moreover, the DC-DC converter 7 has a so-called a maximum power point tracking (MPPT) control function. The MPPT function is the function of the automatic adjustment of operational voltage of the power generator 2 so as to maximize the electrical power generated by means of the power generator 2. A diode is provided (not shown in the figures) between the power generator 2 and the DC-DC converter 7 so as to prevent the reverse flow of the current to the power generator 2.

The battery 3 includes the battery cell 31 connected in parallel with the bus 6, and the charge and discharge unit 32 which performs the electrical charge and discharge of the battery cell 31. As the battery cell 31, a high charge and discharge efficiency ratio rechargeable battery with low natural discharge (e.g. a lithium ion battery cell, a Ni-MH battery cell and the like) are employed. Moreover, the voltage of the battery cell 31 is approximately 48 V.

The charge and discharge unit 32 has a DC-DC converter 33, and the DC bus 6 and the battery cell 31 are connected via the DC-DC converter 33. When charging, the DC-DC converter 33 supplies electrical power from the DC bus 6 side to the battery cell 31 side by reducing the voltage of the bus 6 to a voltage suitable for charging the battery cell 31. Moreover, when discharging, the DC-DC converter 33 discharges the electrical power from the battery cell 31 side to the DC bus 6 side by raising the voltage from the voltage of the battery cell 31 to the vicinity of the voltage of the bus 6 side.

The electrical controller 5 is provided with the memory 5a and the CPU 5b. The electrical controller 5 performs the charge and discharge control of battery cell 31 by controlling the DC-DC converter 33. In order to smooth the power output value to the power grid 50, irrespective of the generated power output of the power generator 2, the controller 5 sets a target output value to the power grid 50. The controller 5 controls the charge and discharge of the battery cell 31 depending on the generated power output of the power generator 2 so that the power output to the power grid 50 becomes the target output value. In other words, in the event that the power output by the power generator 2 is greater than the target output value, the controller 5 not only controls the DC-DC converter 33 to charge the battery cell 31 with the excess electrical power, in the event that the power output by the power generator 2 is less than the target output value, the controller 5 controls the DC-DC converter 33 to discharge the battery cell 31 to make up for the shortfall in the electrical power.

Moreover, the controller 5 acquires the power output data from the detection unit 8 provided on the output side of DC-DC converter 7. The detection unit 8 detects the power output of the power generator 2 and transmits the power output data to the controller 5

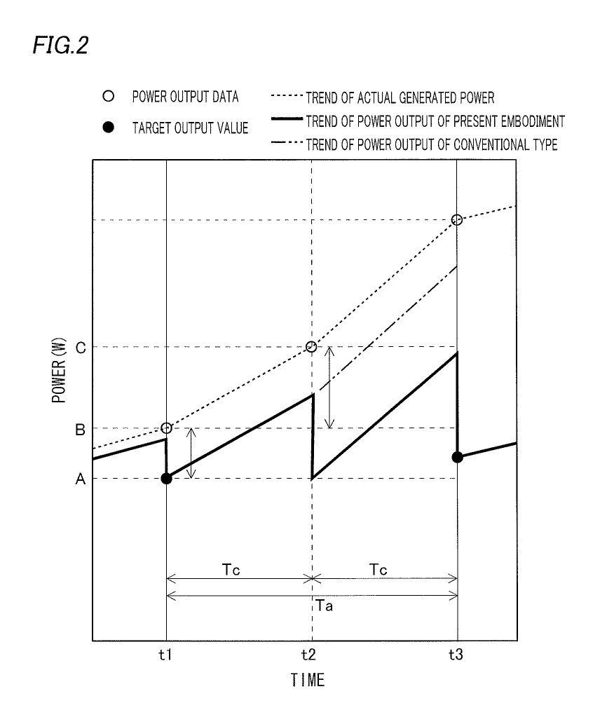

Here, the controller 5 acquires the power output data on each of two different detection time intervals. Specifically, they are the detection time interval (Called the ‘First time interval Ta’) to acquire the power output data in order to compute the target output value, and the detection time interval (Called the ‘Second time interval Tc’) to acquire the power output data in order to correct the target output value. As shown in FIG. 2, the controller 5, as the first time interval Ta, acquires the power output data of the power generator 2 every 30 seconds. This power output data at 30 second intervals is stored successively for a specific time interval in memory 5a (in the first embodiment, 20 minutes as the sampling period described later). Moreover, the controller 5, as the second time interval Tc, acquires the power output data of the power generator 2 at every shorter first time interval Ta. Of this power output data at this shorter time interval, only the latest two data are recorded in memory 5a before the initiation charge and discharge control. The controller 5 by correcting the charged and discharged power output of the battery 3 in computing the amount of fluctuation of the generated power output, based on the power output data for every shorter time interval, suppresses the fluctuations of the actually generated power output better.

The second time interval Tc is not only shorter than the first time interval Ta, the length of the first time interval Ta is set to be an integral multiple times of the second time interval Tc which is equal to or not less than two times. In the first embodiment, while the first time interval Ta is 30 seconds, for example, the second time interval is set to 10 seconds. Moreover, the detection timing of the power output data of the first time interval Ta is set to overlap with the detection timing of the power output data of the second time interval Tc. Now, the second time interval Tc needs to be set to an appropriate value in consideration of the fluctuation period of the generated power output of the power generator 2. In the first embodiment, the second time interval Tc is set so as to be shorter than the fluctuation periods that the load frequency control (LFC) can deal with.

Furthermore, the controller 5, by acquiring the power output of the power output unit 4, recognizes the differences between the actual power output to the power grid 50 from the power output unit 4 and the target output value, enabling the feedback control of the charge and discharge power of the charge and discharge unit 32 in order to cause the power output from the power output unit 4 to be the target output value.

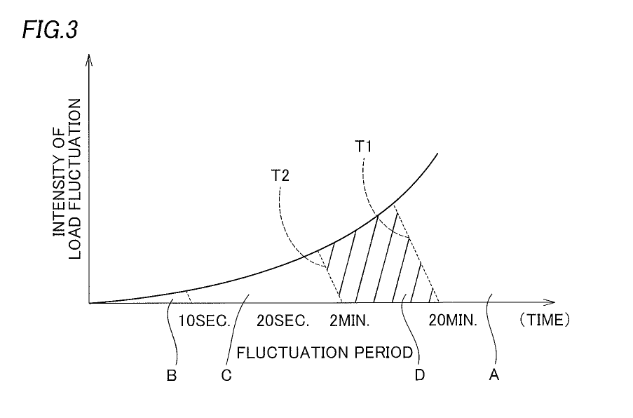

Next, the charge and discharge control of the battery cell 31 by the controller 5 is explained. As described above, the controller 5 controls the charge and discharge of battery cell 31 so that the total of the power generated by the power generator 2, and the amount charged or discharged to/from battery cell 31 becomes the target output value. This target output value is computed using the moving average method based on the power output data acquired in the first time interval Ta. The moving average method is a computation method employing an average of the power generated by the power generator 2 in a period prior to a certain point as a target output value at the certain point, for example. Hereafter, the periods in order to acquire the generated power data used in the computation of the target output value are called the sampling periods. As a specific value for the sampling periods, for example, the periods of not less approximately 10 minutes and not more than approximately 30 minutes in respect of the power grid having the characteristic ‘intensity of load fluctuation-fluctuation periods’ as shown in FIG. 3, and in the first embodiment, the sampling period is set at approximately 20 minutes. In this situation, because the controller 5 acquires the power output data approximately every 30 seconds, the target output value is computed from the average value of 40 data samples on the power output in the last 20 minute interval.

Here, in the first embodiment, the controller 5 does not perform charge and discharge control all of the time, charge and discharge control is only performed when specific conditions are satisfied. In other words, the charge and discharge control is not performed when the output of the power generated by the power generator 2, as is, to the power grid 50 would not result in adverse effects on the power grid 50, and is configured such that charge and discharge control is only performed when the adverse effects would be great. Specifically, the charge and discharge control is configured to initiate in the event that the power generated by the power generator 2 is not less than a specific amount (hereafter referred to as “the control initiating power output”), in addition to initiating the charge and discharge control in the event that the fluctuation amount in the power generated by power generator 2 is not less than a specific amount of fluctuation (hereafter referred to as “the control initiating fluctuation amount”). The control initiating power output is a generated power output which is, for example, greater than the generated power output in rainy weather, specific numerical values, for example, are 10% of the rated power output of the power generator 2.

In the event that the power generated by the power generator 2 as detected on each second time interval Tc moves from a state where it is less than a control initiating power output to a state where it is not less than a control initiating power output, the controller 5 begins the detection of the fluctuation amount of the generated power output of the power generator 2. Then, when the power output of the power generator 2 is a state where it is not less than a control initiating power output, and when the controller 5 determines that the fluctuation amount of the generated power output of the power generator 2 as detected on each second time interval Tc becomes not less than the control initiating fluctuation amount, the charge and discharge control is initiated for the first time. But even when the power output of the power generator 2 is a state where it is not less than a control initiating power output, and the controller 5 determines that the fluctuation amount of the generated power output of the power generator 2 as detected on each second time interval Tc does not exceed the control initiating fluctuation amount, the charge and discharge control is not performed. Moreover, when the controller 5 determines that the fluctuation amount of the generated power output of the power generator 2 remains less than the control initiating fluctuation amount, and when the amount of the generated power output of the power generator 2 detected in each second time interval Tc becomes less than the control initiating power generated amount, the controller 5 terminates the detection of the amount of fluctuation of the generated power output of the power generator 2.

As a numerical value for the control initiating fluctuation amount, for example, when the fluctuation amount is more than the maximum fluctuation amount in each detection time interval (The second time interval Tc) in the noontime of a fine day (Sunny weather with almost no cloud), and as a specific numerical amount, for example, 4% of the pre-fluctuation power output. Moreover, the amount of fluctuation in the generated power output corresponds to the amount of fluctuation computed based on the power output data acquired in the second time interval Tc. The amount of fluctuation in the generated power output is acquired by computing the difference between two consecutive power output data samples detected on the second time interval Tc.

Now, in relation to the specific numerical values cited above (4% of the pre-fluctuation power output, and 10% of the rated power output), when the detection time interval is changed, there is a need to reset the control initiating power output and the control initiating fluctuation amount in accordance with the detection time interval.

Moreover, when the controller 5 performs charge and discharge control, the target output value is computed based on the power output data acquired in the first time interval Ta, and a determination is made of the difference between the actual generated power output and that target output value, and smoothing is performed by charging/discharging that power output from/to battery cell 31. Here, in the first embodiment, the controller 5 corrects the determined charge/discharge power out based on the power output data acquired in the second time interval Tc. This correction of the charge/discharge power output is explained while referring to FIG. 2. Now, in FIG. 2, an example is shown where the second time interval Tc is ½ the first time interval Ta.

As shown in FIG. 2, at time point t1, a determination is made that the difference between the target output value A and the actual generated power output B (B−A) shall be determined as the charged/discharged power after time point t1. In the example in FIG. 2, because the actual power output was greater than the target output value, there is charging to the extent of B−A only. Normally, the charged/discharge power determined at time point t1 remains constant until the next computation point in time for the target output value at time point t3, but in the first embodiment, when the power output data (value C) at time point t2 is detected, the charged/discharge power after the time point t2 is corrected based on the generated power output. In other words, when there is an increase in the generated power output between time point t1 and time point t2, the controller 5 either increases the amount of charged power or decreases the amount of discharged power in step with that increase. Moreover, when there is a decrease in the generated power output between time point t1 and time point t2, the controller 5 either decreases the amount of charged power or increases the amount of discharged power in step with that decrease. By this means, the fluctuations resulting from the fluctuations in the actual power output in between the computation time points of the target output value are suppressed by correcting the charged/discharged power of battery cell 31. In the example in FIG. 2, because there was an increase in the generated power output between time point t1 and time point t2, the controller 5 increased the amount of charged power determined at time point t1(B−A) by the only the amount of the increase in the generated power output at time point t2 (The actual fluctuation in the generated power output between time point t1 and time point t2(C−B)). Therefore, the charged power after time point t2 becomes C−A.

The corrected charge/discharged power (Charged power (C−A)) at time point t2 remains constants until the next computation time point for the target output value at time point t3. Then at time point t3, the new charged/discharged power is determined based on the newly derived target output value. Now, in FIG. 2 the second time interval Tc is ½ of the first time interval Ta, and the correction of the charged/discharged power between computation time points of the target output value is once done. In the case that the second time interval Tc is 1/n (Where n is a positive integer) that of the first time interval Ta, the number of correction events of the charged/discharged power between the computation time points of the target output value is n−1.

Moreover, after the initiation of the charge and discharge control, the controller 5 terminates the charge and discharge control after a certain control period has elapsed. The control periods are periods not less than the sampling periods determined based on the fluctuation period range which at least the load frequency control can deal with. When the control period is too short, the suppression effectiveness of fluctuation period range which the load frequency control can deal with is too little, and when too long, the frequency of the charge and discharge events increases too much, resulting in a tendency to shortening of the lifetime of the battery cell, and there is a need for the setting of an appropriate period length. In the first embodiment, the control period was set at 30 minutes long.

Moreover, in the event that there is the detection of a specific number of fluctuations (three times in the first embodiment) of the generated power output not less than the control initiation fluctuation amount in the control period, the controller 5 is configured to extend the control period. This extension is at the point where the third fluctuation of the generated power output is detected, and is performed by setting a 30 minute control period anew. When the control period is extended, in the event that there are not three more new detections of fluctuations of the generated power output not less than the control initiating fluctuation amount from the point in time of the third detection (The point in time where the extension was initiated), the charge and discharge control is terminated 30 minutes after the third detection (The point in time where the extension was initiated). In the event that there are three more new detections of fluctuations of the generated power output not less than the control initiating fluctuation amount from the point in time of the third detection (The point in time where the extension was initiated), the charge and discharge control is extended a further 30 minutes after the third detection (The point in time where the extension was initiated), and the control period is extended by a further 30 minutes.

Moreover, the controller 5 is configured to terminate the charge and discharge control during the control period, when the generated power output of the power generator 2 falls below the control termination generated power output, even if the control period has not expired. Now the control termination generated power output is a value not more than the control initiation generated power output, and in the first embodiment is set at a value which is half of the control initiating power output.

Here, an explanation is provided of the fluctuation period ranges where fluctuation control is mainly performed by means of the charge and discharge control of the battery cell 31 by means of controller 5. As shown in FIG. 3, the control method which enabled a response to the fluctuation period is different and the fluctuation periods which load frequency control (LFC) can deal with are shown in domain D (The domain shown shaded). Moreover, the fluctuation periods which EDC can deal with are shown in domain A. Now domain B is a domain in which the load fluctuation can be absorbed naturally by the endogenous controls of the power grid 50. Furthermore, domain C is a domain which can be dealt with by the governor free operation of each of the power generators of the generating stations. Here, the border of domain D and domain A is the upper limit period T1 of the fluctuation period which can be dealt with by LFC, and the border of domain C and domain D is the lower limit period T2 of the fluctuation period which can be dealt with by load frequency control. The upper limit period T1 and the lower limit period T2 are not fixed periods in FIG. 3, but it can be appreciated that they are numerical values which vary with the intensity of the load fluctuations. In addition, the time of the fluctuation period shown in the figures will vary with the architecture of the power grid. In embodiment 1, the focus is on the fluctuation periods in the range of domain D (the domain which can be dealt with by LFC) which is the range where EDC, the endogenous control of the power grid 50 or the governor free operation cannot deal with, and the objective is to suppress them.

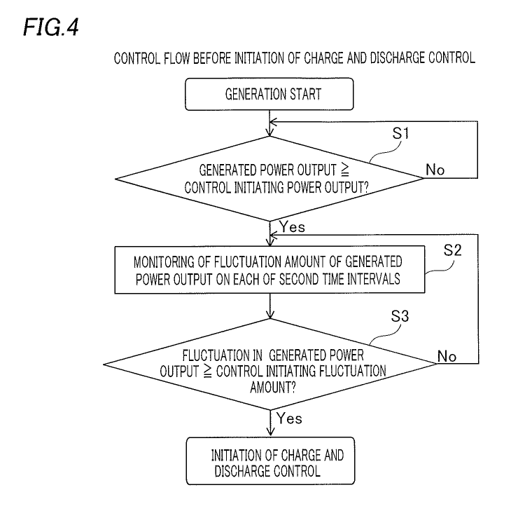

Next, an explanation is provided of the control flow of the power generation system 1 before the initiation of charge and discharge control while referring to FIG. 4.

The controller 5 detects the generated power data by the power generator 2 every first time interval Ta (30 seconds) and every second time interval Tc (10 seconds). Then in step SI, the controller 5 makes a determination as to whether the generated power output acquired in each second time interval Tc is not less than the control initiating power output or not. If the generated power output is less than the control initiating power output, this determination is repeated. If the generated power output is not less than the control initiating power output, in step S2, the controller 5 initiates the monitoring of the fluctuation amount of the generated power output. In other words, the controller 5 computes the difference between two consecutive power output data samples acquired on each of second time intervals Tc as the fluctuation amount.

Then in Step S3, the controller 5 makes a determination as to whether there is a fluctuation in the generated power output which is not less than the control initiating fluctuation amount or not. If there is no fluctuation in the generated power output which is not less than the control initiating fluctuation amount, there is a return to step S2, and the controller 5 continues the monitoring of the fluctuation in the generated power output. Moreover, if there is a fluctuation in the generated power output which is not less than the control initiating fluctuation amount, the controller 5 initiates the charge and discharge control. Now it is not specified in FIG. 4, but for example if the controller 5 in monitoring the fluctuation amount of the generated power output in step S2, and determines that the absolute value of the generated power output is lower than the control termination generated power output, then there is a return to step S1.

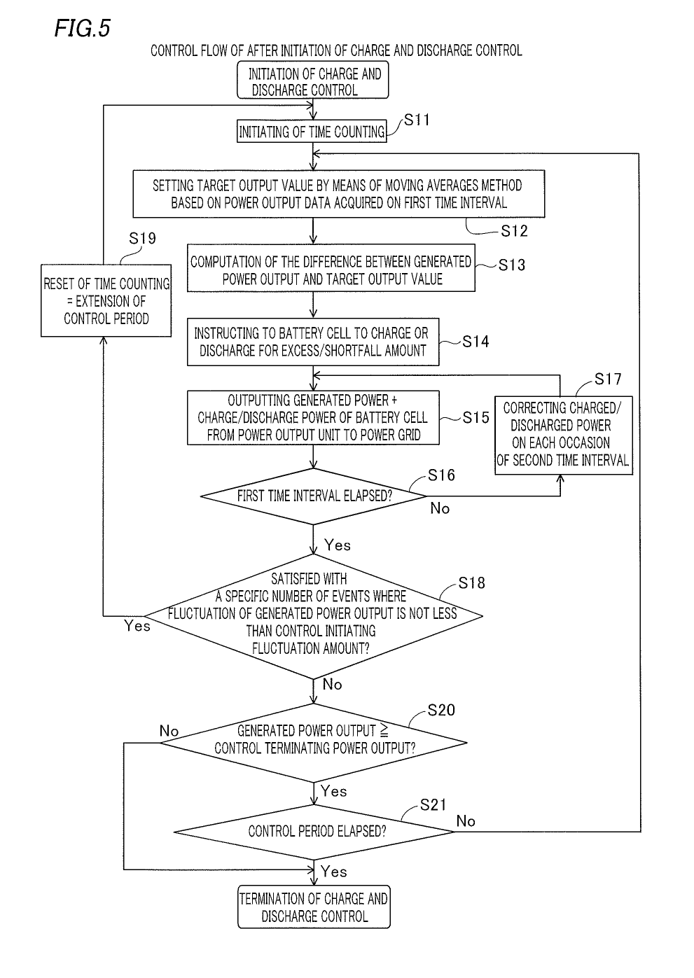

Next, a detailed explanation is provided of the flow of the control of the after initiation of the charge and discharge control while referring to FIG. 5.

After the charge and discharge control is initiated, in step S11, the controller 5 initiates a count of the time elapsed from the starting point of the charge and discharge control.

Next, in step S12, the controller 5 sets the computation of the target output value by means of the moving averages method using the most recently acquired 40 power output data samples on the first time intervals Ta.

Then in step S13, the controller 5 computes the difference between the generated power output detected in the latest on the first time interval Ta after the computation of the target output value, and the target output value set in step S12. Then in step S14, the controller 5, instructs the charging or discharging with respect to the charge and discharge unit 32 for the excess/shortfall amount. In other words, in the event that the target output value is greater than the generated power output, the controller 5 instructs the DC-DC converter 33 to discharge such that the shortfall of the power output of the power generator 2 in respect of the target output value is compensated for by battery cell 31. Moreover, in the event that the target output value is less than the generated power output, the controller 5 instructs the DC-DC converter 33 to charge such that the excess of the power output of the power generator 2 in respect of the target output value is used to charge the battery cell 31.

Then, in step S15, the target output value is output (The power generated by the power generator 2+the charge/discharge power of the battery cell 31) from the power output unit 4 to the power grid 50.

Thereafter in step S16, the controller 5 makes a determination as to whether an amount of time equal to the first time interval Ta has elapsed or not. In the event that it has not elapsed, in step S17, the controller 5 continues the charge/discharge while correcting the charged/discharged power on each occasion of the second time interval Tc, and repeats the steps S15˜step S17 until the first time interval Ta has elapsed.

Moreover, when an amount of time equal to the first time interval Ta has elapsed, in step S18, the controller 5 makes a determination as to whether, with a generated power output which is not less than the control initiating power output, there was in addition a specific number of events (three times in embodiment 1) in the control period (30 minutes) where the fluctuation of the generated power output was not less than a specific fluctuation amount (the control initiating fluctuation amount), or not. In the event that there were three events where the amount of the fluctuation exceeded the control initiating fluctuation amount, because there is the possibility that the fluctuations in the generated power output would continue thereafter, in step S19, the controller 5 not only resets the count of the elapsed time, the period of the charge and discharge control is extended. In that event, there is a return to step S11, and the controller 5 reinitiates the count of the elapsed time once more.

Then, in the event that the number of fluctuations of the generated power output not less than the control initiating power output was less than three times, in step S20, the controller 5 makes a determination as to whether the generated power output of the power generator 2 is not less than a specific generated power output (the control terminating power output) or not. Then, in the event that the generated power output is not less than the control terminating power output, in step S21, the controller 5 makes a determination as to whether the control period (30 minutes) has elapsed since the initiation of the charge and discharge control, or since the extension of the control period of the charge and discharge control period has elapsed. In the event that the control period has elapsed, the controller 5 terminates the charge and discharge control. In the event that the control period has not elapsed, there is a return to step S12, and the charge and discharge control is continued.

Moreover, in the event that a determination is made that the generated power output was less than the control terminating power output in step S20, the controller 5 terminates the charge and discharge control even if the control period has not completely elapsed. Now this step S20 may be entered anywhere in the control flow.

The power supply system of the first embodiment with the configuration as described above enables the derivation of the following benefits.

The controller 5 acquires the power output data on the second time period Tc which is shorter than the first time interval Ta whereon the generated power data was acquired in order to compute the target output value, and corrects the charge and discharge of the battery 3 based on the generated power data acquired in the second time interval Tc. By means of this type of configuration, the charged/discharged power of the battery 3 determined based on the target output value can be adjusted based on the actual generated power output. By this means, because the performance of the charge and discharge of the battery 3 in order to better suppress the fluctuations in the actual power output (smoothing) is enabled, the suppression of the [effects of] the fluctuations in the power output on the power grid 50 is enabled effectively. As a result, the suppression of the adverse effects on the frequency and the like of the power grid 50 is enabled. Moreover, by performing the charge and discharge control of the battery 3 based on the target output value computed based on the power output data acquired in the relatively long first time interval Ta, because the increase in the amount of the power output data in order to compute the target output value can be suppressed compared with the situation where the computation of the target output value uses the power output data acquired at the relatively short second time intervals Tc, the suppression of the increase in the recording capacity of the memory 5a is enabled, as well as enabling the suppression of the a great increase in the processing load in the computation processing of the controller 5.

Moreover, the controller 5 corrects the charge/discharge power of the battery 3 which was determined at the computation point of the target output value using the generated power output acquired in the period to the next computation time point of the target output value. By means of this type of configuration, the correction of the charge/discharge power determined at the computation time point of the target output value is enabled based on the detected generated power output until the next computation point of the target output value. By this means, unlike where the charged/discharged power was maintained constant between the computation time points of the target output value, even when there is fluctuation in the generated power output between the computation time points of the target output value, the adjustment of the charged/discharge power is enabled in order to suppress the fluctuations in the generated power output.

Moreover, the controller 5 corrects the charge/discharge power of the battery 3 in accordance with the difference between the value of the power output data at the computation time point of the target output value, and the value of the power output data acquired on every second time interval Tc. By means of this type of configuration, the adjustment of the charged/discharged power of the battery 3 is enabled in accordance with the amount of fluctuation in the generated power output in the period from the computation of one target output value to the computation of the next target output value. By this means, even when the actual generated power output fluctuates between the computation time points of the target output value, the adjustment of the charge/discharge power in order to suppress the fluctuations in the generated power output is enabled.

Moreover, the controller 5 corrects the charged/discharged power of the battery 3 on every occasion of the second time interval Tc. By means of this type of configuration, because detailed adjustment of the charge/discharge power of the battery 3 is enabled in the period between the computation time points of target output value, the more effective suppression of the fluctuations in the power output to the power grid 50 is enabled.

Furthermore, the controller 5, on the occasions of performing the charge and discharge control of the battery 3, not only computes the target output value by means of the moving averages method based on the power output data recorded in the memory 5a for 20 minutes of each of the first time intervals Ta, but also corrects the charged/discharged power of the battery 3 based on the power output data for each second time interval Tc. By means of this type of configuration, in addition to recording only 40 power output data values in memory 5a in order to compute the target output value, by recording only two power output data in the memory 5a in order to compute the correction amount of the charge/discharge power of the battery 3, the correction of the charge/discharged power of the battery 3 is enabled. By this means, unlike merely shortening the detection time intervals of the generated power output in order to compute the target output value, the better suppression of the fluctuations in the actual generated power output (smoothing) is enabled by performing the charge/discharge of the battery 3, without increasing the amounts of data on the generated power output stored in the memory 5a.

Furthermore, the controller 5 performs the charge and discharge control so as to output the computed target output value based on the power output data in the range of the sampling period set as a period not less than the lower limit period of the fluctuation periods which the load frequency control (LFC) can deal with. By means of this type of configuration, in particular, the components of the fluctuation periods which the load frequency control can deal with can be decreased. By this means, the effects imparted to the power grid 50 may be suppressed.

Furthermore, the first time interval is an integral multiple of the second time interval, and the generated power output detection timing of second time interval is configured to overlap with the generated power output detection timing of first time interval. By means of this type of this configuration, because the detection frequency of the generated power output can be minimized (The sum of the frequency of the detection in the first time interval and the detection frequency in the second time interval), the power output data can be acquired easily and the performance of the determination of whether to perform charge and discharge control or not is enabled.

Next, the sampling period of the moving averages method is investigated.

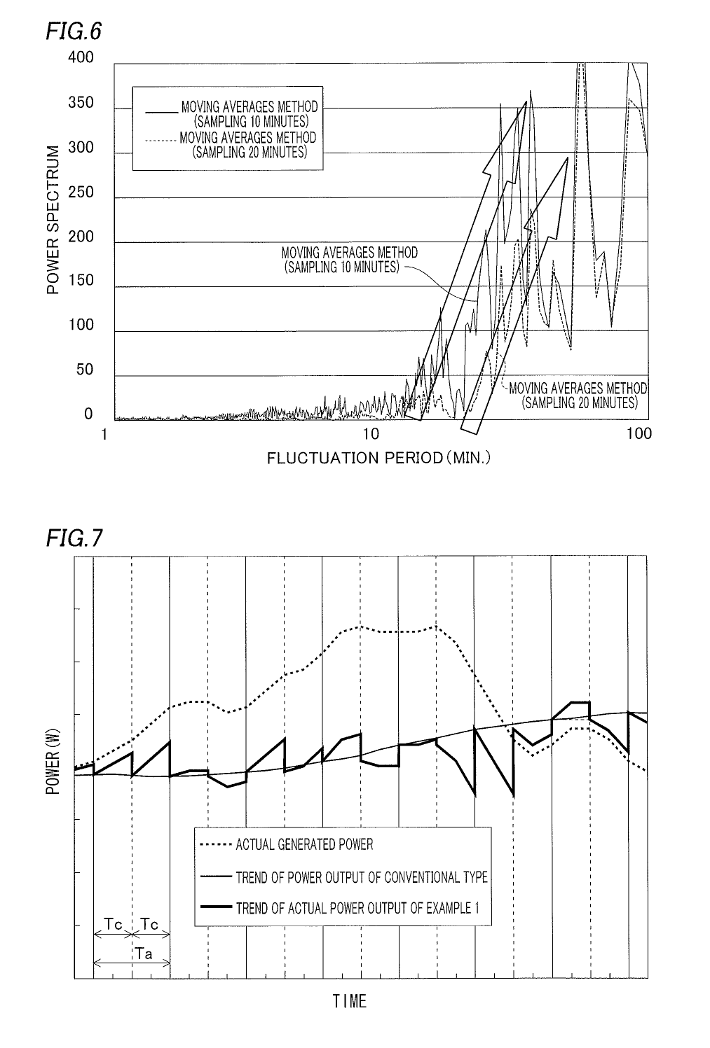

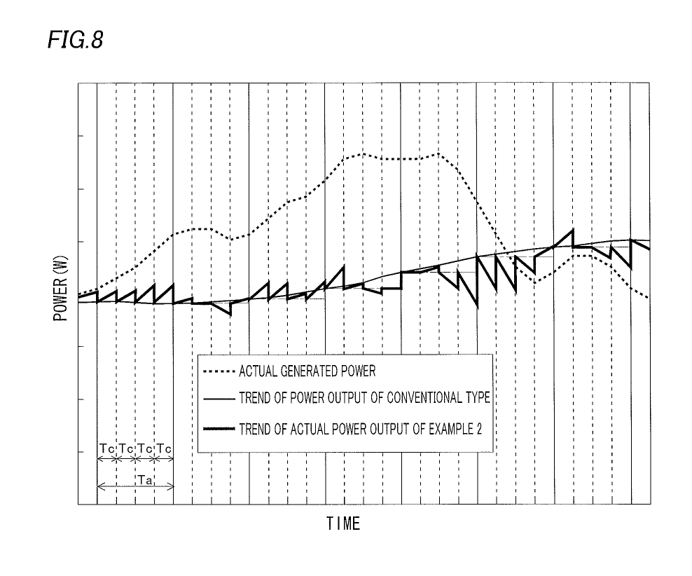

FIG. 6 shows the results of the FFT analysis of the power output data when the sampling period which is the acquisition period of the power output data was 10 minutes, and the results of the FFT analysis of the power output data when the sampling period was 20 minutes. As shown in FIG. 6, when the sampling period was 10 minutes, while the fluctuations in respect of a range of up to 10 minutes of a fluctuation period could be suppressed, the fluctuations in a range of fluctuation periods which were not less than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were not less than 20 minutes was not suppressed well. Therefore, it can be understood that there is a good mutual relationship between the length of the sampling period, and the fluctuation period which can be suppressed by the electrical charge and discharge control. For this reason, it can be appreciated that by setting the sampling period, the range of the fluctuation period which can be controlled effectively changes. In that respect, in order to suppress parts of the fluctuation period which can be addressed by the load frequency control which is the main focus of this system, it can be appreciated that in order that sampling periods which are not less than the fluctuation period corresponding to what the load frequency control can deal be set, in particular, it is preferable that they be set from the vicinity of the latter half of T1˜T2 (The vicinity of longer periods) to periods with a range not less than T1. For example, in the example in FIG. 3, by utilizing a sampling period of not less than 20 minutes, it can be appreciated that suppression of most of the fluctuation periods corresponding to the load frequency control is enabled. However, when the sampling period is made longer, there is a tendency that the required battery capacity grows large, and it is preferable to select a length of sampling period which is not much longer than T1.

Next, a detailed explanation is provided of the results of a simulation to investigate the effectiveness of using the power supply system 1 while referring to FIG. 7˜9.

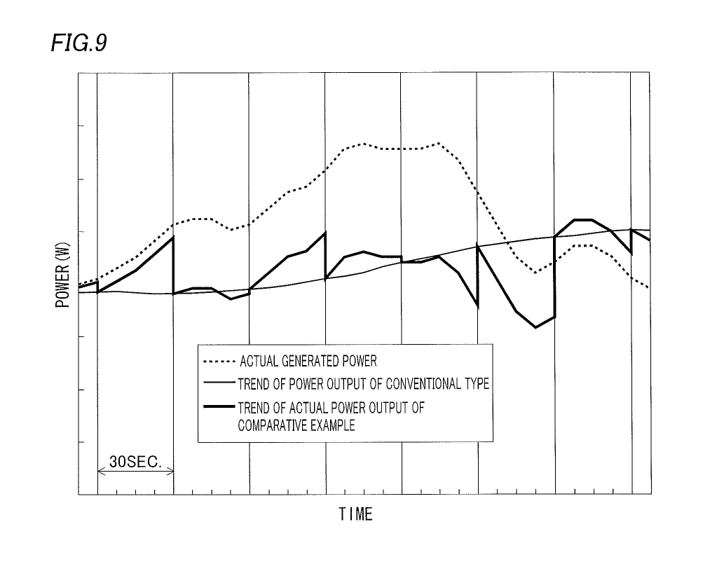

FIG. 7˜FIG. 9 show the trends of the power output in each of example 1, example 2 and the comparative example, respectively, when charge and discharge control were performed. Examples 1 and 2 performed the same control as was performed in embodiment 1. Now, example 1 is an example where the second time interval Tc is ½ of the first time interval Ta, and example 2 is an example where the second time interval Tc is ¼ of the first time interval Ta. The comparative example is an example where the same charge and discharge control as conventionally was performed. Moreover, the computation time interval (The first time interval Ta) for the target output value was 30 seconds in example 1, example 2 and the comparative example.

As shown in FIG. 7˜FIG. 9, in examples 1 and 2, because the charged/discharged power was corrected on each occasion of the second time interval Tc, the fluctuations in the actual power output are smaller compared to the comparative example. Moreover, in the smaller Tc of example 2 compared to example 1, as a result of a more minute charge/discharge power correction, it can be appreciated that the power output was closer to the target output value compared to example 1, and the fluctuations in the power output are reduced.

### Embodiment 2

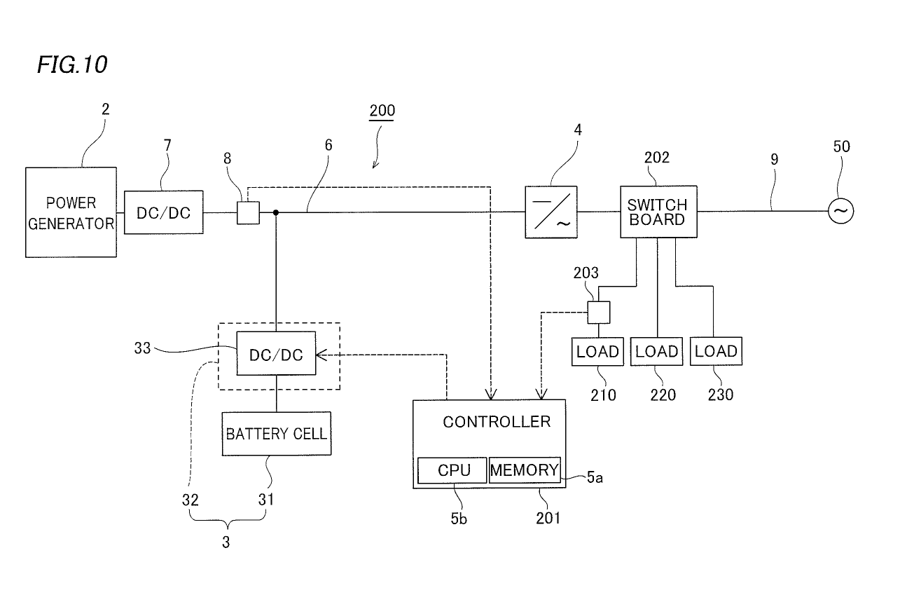

Next, the power supply system 200 of the second embodiment of the present invention is explained, while referring to FIG. 10. In this second embodiment, in addition to performing the charge and discharge control of embodiment 1, an example is explained where the charge and discharge control of the battery cell 31 is in accordance with the operational state of load 210.

As shown in FIG. 10, the power supply system 200 provides the power generator 2, the battery 3, the power output unit 4, the controller 201, the DC-DC converter 7, and the detection unit 8. Moreover, the switchboard 202 is provided on the alternating current side bus 9 between the power output unit 4 and the power grid 50. The three loads 210, 220 and 230 are connected to the alternating current side bus 9, via switchboard 202. Here, load 210 is often employed in the time (approximately 2 minutes˜approximately 20 minutes) between the lower limit period T2 and upper limit period T1 of the fluctuation periods which load frequency control (LFC) can deal with, in addition, it is a load which has a relatively large power consumption, for example and IH heater and the like. Furthermore, loads 220 and 230 are loads which rarely switch ON/OFF or have low power consumption such as lighting and the like.

In embodiment 2, a sensor 203 for detecting the operational state of load 210 is provided. The controller 201 can determine whether the load 210 is being used (ON) or not being used (OFF) based on the output signal of sensor 203. The controller 201, in addition to performing the charge and discharge control of the first embodiment, also controls the charge and discharge of the battery cell 31 in order to suppress the fluctuation of the power entering or leaving the power grid 50 occurred as a result of the switching ON/OFF of load 210. In other words when a determination is made that the load 210 changed from being OFF to ON, the additional consumption of load 210 causes a reduction in the counter current flow of the power (the power selling) from the power supply system 200 to the power grid 50, or increases the power entering (the power purchase) from power grid 50 to the power supply system 200. Because of this, the controller 201 discharges the battery cell 31 in order to control the increase in the power purchase or the reduction in the power selling. In the same manner when a determination is made that the load 210 switched from ON to OFF, because the consumption of load 210 decreases, increasing the amount of the power selling, or the amount of the power purchase is decreased, the charging of the battery cell 31 is performed, in order to suppress the increase in the power selling or the decrease in the power purchase.

Just as described above, the controller 201 not only detects the fluctuation in the operational state of load 210 connected to the alternating current side bus 9 between the power generator 2 and the power grid 50, it also performs the charge and discharge of battery 3 so as to suppress the fluctuation of the power entering/leaving the power grid 50 generated in line with the fluctuation in the operational state of load 210. By being configured in this manner, for example, in a situation where counter current flow is being generated, with the operation of load 210, the power output to the power grid 50 is reduced by the amount of power consumption by load 210, and at least part of that reduced amount can be discharged from the battery 3. Moreover, in the situation where the load 210 is terminated and the power output to the power grid 50 is increased by the amount of power consumption of load 210, at least part of that increased amount may be charged into the battery 3. By this means because the fluctuations in the power leaving/entering the power grid 50 in line with the operational state of the load 210 can be suppressed, the effects imparted to the power grid 50 may be suppressed.

Furthermore, even in the configuration of embodiment 2, because an appropriate suppression of the fluctuations of the power leaving/entering the power grid 50 are enabled, the same benefits as in Example 1 may be derived.

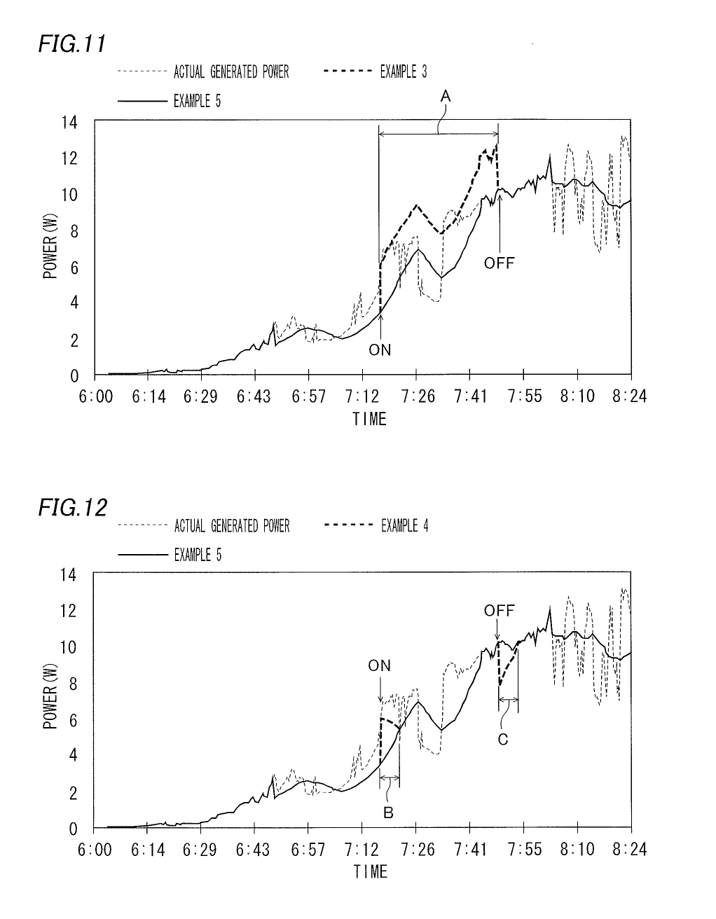

Next, an explanation is provided of the results of a simulation to investigate the effectiveness of using the second embodiment of the present invention while referring to FIG. 11˜15.

In this simulation, in respect to the generated power output trends of power generator 2, the power output trends of the power output to the power grid 50 when control was performed by means of the second embodiment were investigated. As the control of the second embodiment, Example 3 shows the switching ON/OFF of the load 210, while performing the charge and discharge control of the first embodiment, the continuous discharge of the battery cell 31 was performed in the periods when the load 210 is ON. In other words, in Example 3, charge and discharge control is performed while including in the calculations the discharged power of the consumed power of the load periods of 210 when load 210 is switched ON, in addition to the computed charge and discharge of power to/from battery cell 31 in embodiment 1.

Moreover, as the control of embodiment 2, in Example 4, the load 210 is being switched between ON/OFF while performing the charge and discharge control of embodiment 1, immediately after switching, charge/discharge is performed while adding the discharged power (when ON), or the charged power (when OFF), of the consumed power of load 210 to the charged and discharged power of battery cell 31 computed in embodiment 1, thereafter, the battery cell 31 is controlled such that the power added immediately after switching is gradually approximated to 0 over 5 minutes.

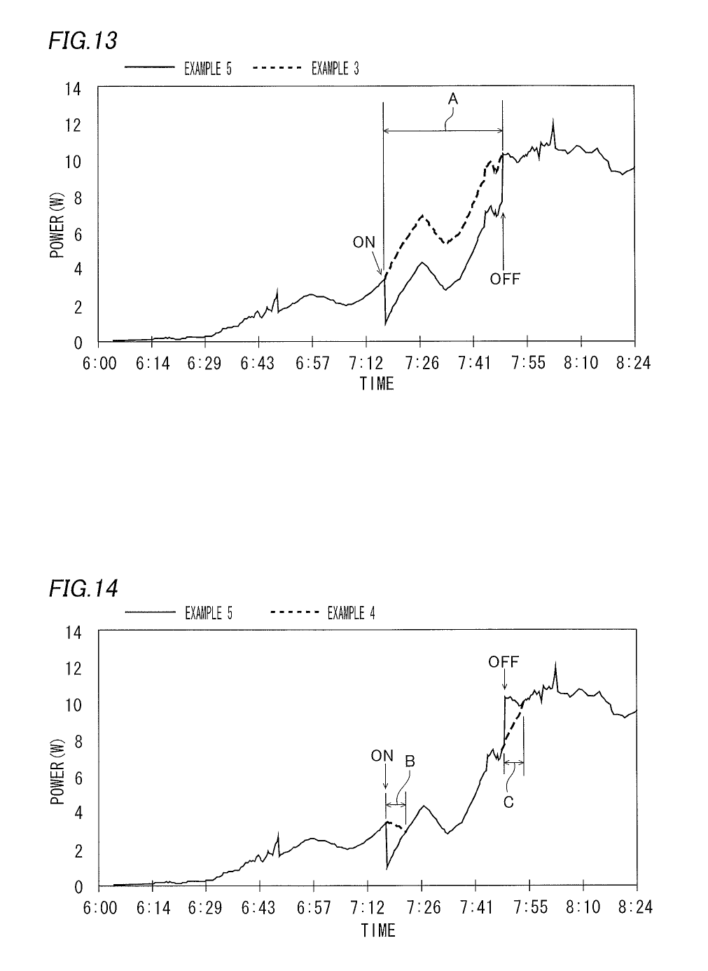

Moreover, in example 5 only the control of the first embodiment is performed. FIG. 11 and FIG. 12 show the trends of the power-output output from the power output unit 4 when control was performed in examples 3, 4 and 5. FIG. 13 and FIG. 14 show the trends of the power output of the counter current flow to the power grid 50 side when control was performed by examples 3, 4 and 5 (more precisely, the trend of the power output passing between load 210 and load 220).

As shown in FIG. 11, in example 2, in the period A from when load 210 was switched from ON to OFF, the power output is based on the trend of the computed generated power output shown in example 5, with the consumed power of the load 210 added thereto. Therefore, in period A of example 3, the power consumption of load 210 was added to the discharged power from battery cell 31 compared with example 5. In the periods other than period A the trends of example 3 and example 5 are the same.

Furthermore, as shown in FIG. 12, in example 4, in the period B in the five minutes from when load 210 was switched ON, the power output had the consumed power of load 210 added to the power output computed based on the trends of the generated power output of the type shown in example 4 in the beginning of period B, and thereafter it was gradually reduced to the same output as in example 5. On that occasion, in the period B in example 4, the charged and discharged power of battery cell 31 was computed so as to add the discharged power of the consumed power or load 210 when load 210 was ON, and that additional discharged power was gradually reduced to zero over five minutes.

Moreover, in the period C of five minutes from when the load 210 was switched OFF, example 4 is the power output where the consumed power of load 210 is subtracted from the computed power output based on the trend of the generated power output as shown in the start of the period C in example 5, thereafter the output was gradually increased to the same output in example 5. On that occasion, in respect to the period C in example 4, the charged and discharged power computed for battery cell 31 subtracts the discharge power of the consumed power of load 210 when load 210 is OFF, this subtracted discharged power is gradually reduced to zero over five minutes.

Here, as shown in FIG. 13 and FIG. 14, in example 5, because the output power from power output unit 4 is reduced by the power consumed by load 210, in respect to when the load 210 is ON and when it is OFF, the power output to power grid 50 generates an abrupt fluctuation. In contrast to this, in examples 3 and 4, in respect to the periods A˜C where there was a large fluctuation in example 5, the trend in the output power to power grid 50 is smoothed without any abrupt fluctuation. Therefore, in examples 3 and 4 it can be appreciated that the impact on power grid 50 is less than in example 5.

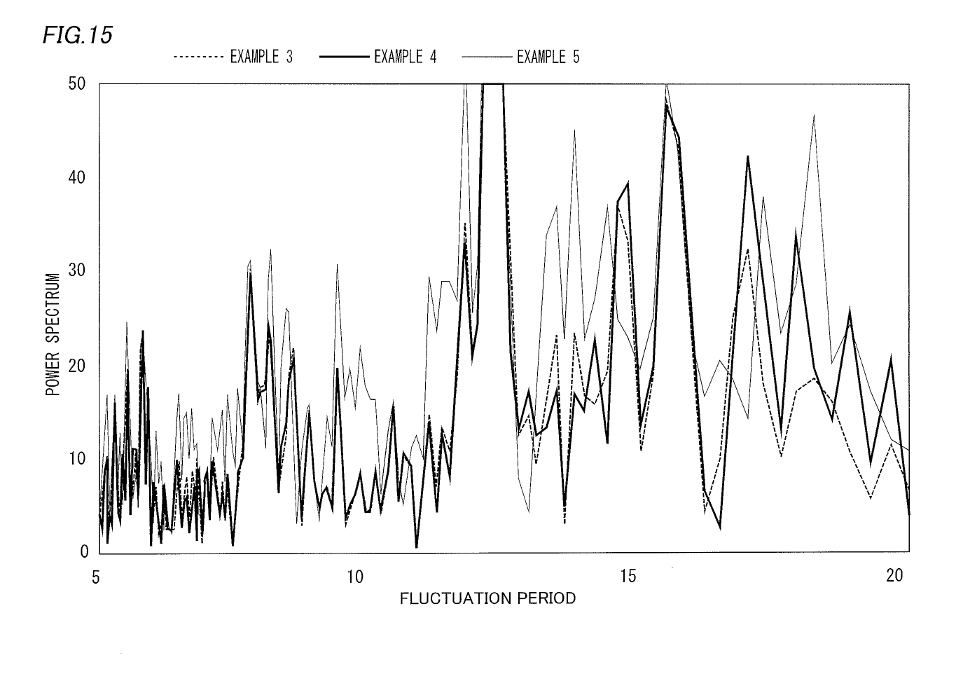

Furthermore, as shown in FIG. 15, in examples 3 and 4, the overall frequency fluctuations are suppressed when compared to example 5. Moreover, examples 3 and 4 suppress the frequency fluctuations at substantially the same level. Here, as shown in FIG. 11 and FIG. 12, in example 3 unlike in the case of example 2, there is no need to normally add the discharged power consumed by load 210, and because in period B while the power consumed by load 210 is added, in period C, in order to control such that the power consumed by load 210 is subtracted, it is difficult for the charge and discharge of battery cell 31 to be biased toward only one of the charging direction, or the discharging direction. As a result, it can be appreciated that the enablement of the suppression of the discharge depth of battery cell 31 and the like, the lengthening of the lifetime of battery cell 31 and the reduction in the capacity thereof is more effectively enabled in examples 4 than in example 3.

### Embodiment 3

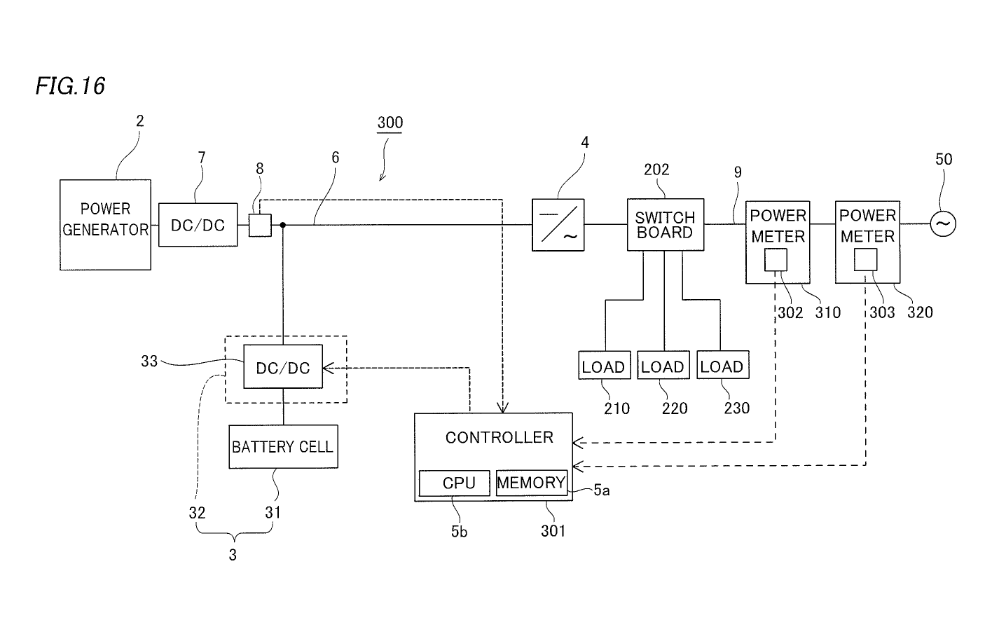

Next, an explanation is provided in regard to the power supply system 300 of the third embodiment of the present invention, while referring to FIG. 16. In embodiment 1, an example was shown where charge and discharge were performed based on the generated power output. On the other hand, in this third embodiment, an example is explained where the charge and discharge control is performed based on the output/input power to/from power grid 50 (the power selling or the power purchase).

As shown in FIG. 16, the power supply system 300 provides the power generator 2, the battery 3, the power output unit 4, the controller 301, the DC-DC converter 7 and the detection unit 8. Moreover, the three loads 210, 220 and 230 are connected via the switchboard 202 to the alternating current side bus 9 between the power output unit 4 and the power grid 50.

Furthermore, the power meter 310 measuring the power sold to the power grid 50 from the power supply system 300 and the power meter 320 measuring the power bought from power grid 50 are provided on the alternating current side bus 9 closer to the power grid 50 side than the switchboard 202. The power sensor 302 and the power sensor 303 are provided, respectively, on the power meter 310 and the power meter 320, detecting the power data exiting and entering between the power grid 50 and the power supply system 300 (the power selling data or the power purchase data).

The controller 301 acquires the power purchase data or the power selling data from power sensors 302 and 303 on a specific detection time interval (for example, not more than 30 seconds). The controller 301 computes the power selling minus the power purchase value as the leaving and entering power data (when the power selling and the power purchase are values not less than zero). Even in the third embodiment just as in the first embodiment, the controller 301 acquires the leaving and entering power data for each of the first time intervals Ta and the second time intervals Tc. Moreover, the controller 301 not only computes the target output value based on the past leaving and entering power data, it also performs the charge and discharge of the battery cell 31 so as to compensate for at least part of the difference between the actual leaving and entering power and the target output value. In other words, when the actual leaving or entering power is greater than the target output value, the controller 301 is configured to not only control the DC-DC converter 33 in order to charge the battery cell 31 with at least part of the excess power, but also when the actual leaving or entering power is less than the target output value, to control the DC-DC converter 33 in order to discharge at least part of the shortfall power from the battery cell 31.

Furthermore, the controller 301 is configured in order to initiate the charge and discharge control when the generated power output of the power generator 2 is not less than a specific power output (the control initiating power output), in addition to when the amount of fluctuation of the leaving and entering power (the power selling or the power purchase) is not less than a specific fluctuation amount (the control initiating fluctuation amount). Moreover, the amount of fluctuation of the leaving and entering power is computed based on the leaving and entering power data for each of the second time intervals Tc. Furthermore, the target output value is computed based on the leaving and entering power data for each of the first time intervals Ta. The control initiating fluctuation amount of embodiment 3 is set as a fluctuation amount which is greater than the maximum fluctuation amount between the detection time intervals in respect to the midday time period of fine weather (fine weather where there are almost no clouds), in addition to being set in consideration of the second time interval Tc, the loaded amount and such like. In particular in embodiment 3, because the leaving and entering power (=the power selling−the power purchase) becomes a positive or negative value, it is not simply a comparison of the fluctuation amount of the generated power output with the generated power output before the fluctuation as shown in embodiment 1 and the like, for example the rated power output of the power generator 2, the rated power consumption of the loads and the like are taken into consideration, and a method of control of the absolute value of the fluctuation amount or alternatively, a method which adds an appropriate power output to the output and input power (=the power selling−the power purchase) in correspondence with the amount of the load is preferable. In the third embodiment the control initiating fluctuation amount is 2% of the rated power of the power generator 2.

The setting of the sampling period, the computation method of the target output value, and the waiting time and the like in relation to the charge and discharge control are the same as in embodiment 1.

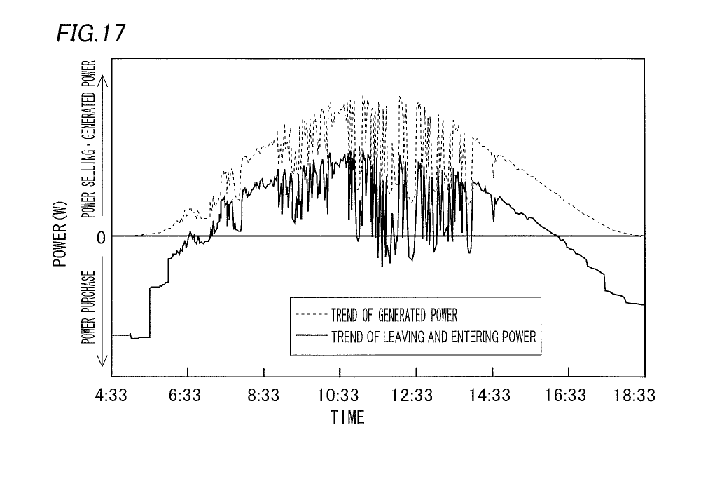

FIG. 17 shows the trends of the generated power output of the power generator 2 on a particular day and the trends of the output and input power (=the power selling−the power purchase) on the same day. The trends of the leaving and entering power more or less correspond to the trends of the generated power output less the consumed power of the loads (loads 210, 220 and 230). As shown in FIG. 17, because the frequency of abrupt fluctuations in the power consumption of loads during one day in respect to a general household is not high, the trends of the generated power output and the trends of the leaving and entering power fluctuate in substantially the same manner. Therefore, by performing the charge and discharge control based on the leaving and entering power, the suppression of the fluctuations of the leaving and entering power, and the suppression of the effects on the power grid 50 are enabled.

In embodiment 3, as described above, the controller 301 performs the charge and discharge control of the battery 3 correcting the charged/discharge power of battery 3 based on leaving and entering power data acquired in the second time interval Tc. By means of this type of configuration, the charged and discharged power of battery 3 determined based on the target output value, can be adjusted based on the actual generated power output. By this means, because the performance of the charge/discharge of the battery 3 so as to control (smooth) the fluctuations in the actual power output is enabled, the more effective suppression of the fluctuations in the output to the power grid are enabled, and as a result, the effective suppression of the adverse impact on the frequency and the like of the power grid 50 is enabled. Moreover, by the computation of the target output value based on the data of the leaving and entering power data, and the performance of the charge and discharge of the battery 3, because the suppression of the enlargement of the data set of the leaving and entering power in order to compute the target output value compared with the situation where the target output value is computed based on the leaving and entering power output data acquired in the second time interval Tc is enabled, the suppression of the enlargement of the capacity of the memory 5a is enabled.

Furthermore, even in the configuration of the third embodiment because an appropriate suppression of the fluctuations of the power output leaving and entering the power grid 50 are enabled, the same benefits as in embodiment 1 are derivable.

Now, in the embodiments and examples disclosed here, it should be considered that all points were for the purposes of illustration and the invention is not limited to those points. The scope of the present invention is not defined by those embodiments explained but by the scope of the claims of the invention, and in addition, all equivalent meaning to the scope of the claims and all modifications within the range of the scope of the claims are included in the invention.

Moreover, in embodiments 1˜3 described above, examples were shown where lithium ion batteries or Ni-MH batteries were employed as the battery cells, but the present invention is not limited to these, and other rechargeable batteries may be employed. Moreover, as one example of the ‘battery, a capacitor may be employed instead of the power battery cell.

Moreover, in the embodiments 1˜3 and the examples described above, an explanation was provided whereby the voltage of the battery cell 31 is 48 V, but this invention is not limited to this, and can be a voltage other than 48 V.

Furthermore, in the embodiments 1˜3 and the examples described above, an explanation was provided whereby the control initiating power output was 10% of the rated power output of the power generator 2, and where the control initiating fluctuation amount was 5% of the pre-fluctuation generated power output of the power generator 2, but the present invention is not limited to these, and numerical values other than those cited above may be employed. For example, the control initiating fluctuation amount may be set based on the rated power output of the power generator. However, it is preferable that the size of the control initiating power output is greater than the size of the control initiating fluctuation amount.

Moreover, in embodiments 1˜3, an example was explained whereby where the power output data acquired in the second time interval Tc (The detected power output) was employed in the determination of the timing of the initiation of the charge and discharge control, and the correction of the charged and discharge power, but the present invention is not limited to this, and it may be employed only for the correction of the charged and discharge power output.

Furthermore, in embodiments 1˜3 described above, and in the examples, examples were explained where a determination was made as to whether to initiate the charge and discharge control or not based on the amount of fluctuation of the generated power output acquired in the second time period, but the present invention is not limited to these, and the determination of whether to initiate the charge and discharge control may be based on the generated power value itself acquired in each of the second time intervals. For example, the determination to perform the charge and discharge control may be performed based on when the generated power output is greater than a specific value (Threshold value) acquired on the occasion of the second time intervals. Moreover, the same applies to the termination of the charge and discharge control, for example, the determination to terminate the charge and discharge control may be made when the generated power output is less than a specific generated power output (Threshold value) acquired in the second time intervals.

Moreover, in embodiments 1˜3 described above, and in the examples, examples were explained where the target output value was computed by means of the moving averages method, but the present invention is not limited to these, and the present invention can be adapted to a situation where the target output value is computed based on plural power output data included within a sampling period (e.g. 20 minutes). For example, in the initial period of the computation of the target output value, the sampling period may be temporarily shortened.

Furthermore, in embodiments 1˜3 described above, and in the examples, examples were explained with a configuration wherein the timing of the detection time of the first time interval Ta and the timing of the detection time of the second time interval Tc overlapped, but the present invention is not limited to these, and the timing of the detection time of the first time interval Ta and the timing of the detection time of the second time interval Tc may be staggered.

Moreover, in embodiments 1˜3 described above, an example was described where the charged and discharged power output of the battery 3 was corrected on each occasion of detection of the power output data (Detected power output data) in respect of the computation time point of the target output value, but the present invention is not limited to these, and the correction of the charged and discharge power output need not be performed on every occasion of the second time interval Tc. For example, a configuration may be employed wherein the performance of the correction of charged and discharged power output is not performed when specific conditions are met (When the fluctuation in the actual generated power output is small and the like).

Furthermore, in embodiments 1˜3 described above, an example was explained where the correction of the charge and discharged amount was merely the fluctuated amount of the actual generated power output, but the present invention is not limited to these, and the correction of the charge and discharged amount may be less than the fluctuated amount of the actual generated power output.

Furthermore, in the second embodiment, an example was explained where the charge and discharge control of the battery cell 31 was based on the output signal of the sensor 203 detecting the ON/OFF of the load 210, but the present invention is not limited to this, and the control of the charge and discharge of the battery cell 31 may be based on the output signal of the power sensor detecting the consumed power of the load 210.

1. An electric power generation system, comprising:
a power generator configured to generate electric power using renewable energy;
a battery configured to store electric power generated by the power generator;
a detector configured to acquire a first power amount data for every first time interval and a second power amount data for every second time interval which is shorter than the first time interval, the first power amount data and the second power amount data being amounts of electric power flowing on a line connecting the power generator and an electric power transmission system;
a controller configured to compute a target output value for the electric power to be supplied to the electric power transmission system based on the first power amount data, to compute a charge or discharge value that is an amount of electric power for charging or discharging the battery based on the target output value, to correct the charge or discharge value based on the second power amount data, and to charge or discharge the line with electric power corresponding to the charge or discharge value from the battery.

2. The system of claim 1, wherein the target output value is computed at each first time interval, the charge or discharge value is computed based on the target output value computed in one of the first time intervals, and the charge or discharge value is corrected based on the second power amount data detected in one of the second time intervals that immediately follows the computation of the charge or discharge value.

3. The system of claim 2, wherein the charge or discharge value is corrected in accordance with a difference between the first power amount data computed in the one of the first time intervals and the second power amount data detected in the one of the second time intervals.

4. The system of claim 1, wherein the charge or discharge value is corrected based on the second power amount data at each second time interval.

5. The system of claim 1, wherein the first time interval is an integral multiple of the second time interval, and the detection of the power output of the first time interval coincides with the detection of the power output of the second time interval.

6. A method of controlling a battery storing electric power generated by a power generator generating electric power using renewable energy, comprising:
detecting a first power amount data for every first time interval and a second power amount data for every second time interval which is shorter than the first time interval, the first power amount data and the second power amount data being amounts of electric power flowing on a line connecting the power generator and an electric power transmission system;
computing a target output value for the electric power to be supplied to the electric power transmission system based on the first power amount data;
computing an charge or discharge power amount from battery based on the target output value;
correcting the charge or discharge power amount based on the second power amount data; and
charging or discharging the line with electric power corresponding to the charge or discharge value from the battery.

7. A computer-readable recording medium which records a control programs for causing one or more computers to perform the steps comprising:
detecting a first power amount data for every first time interval and a second power amount data for every second time interval which is shorter than the first time interval, the first power amount data and the second power amount data being amounts of electric power flowing on a line connecting the power generator and an electric power transmission system;
computing a target output value for the electric power to be supplied to the electric power transmission system based on the first power amount data;
computing an charge or discharge power amount from battery based on the target output value;
correcting the charge or discharge power amount based on the second power amount data; and
charging or discharging the line with electric power corresponding to the charge or discharge value from the battery.

8. A device controlling a battery storing electric power generated by a power generator generating electric power using renewable energy, comprising:
a detector configured to acquire a first power amount data for every first time interval and a second power amount data for every second time interval which is shorter than the first time interval, the first power amount data and the second power amount data being amounts of electric power flowing on a line connecting the power generator and an electric power transmission system;
a controller configured to compute a target output value for the electric power to be supplied to the electric power transmission system based on the first power amount data, to compute an charge or discharge value that is the amount of electric power for charging or discharging the battery based on the target output value, to correct the charge or discharge value based on the second power amount data, and to charge or discharge the line with electric power corresponding to the charge or discharge value from the battery.
